(19) United States
(12) Patent Application Publication
(10) Pub. No.: US 2018/0208057 A1
(43) Pub. Date: Jul. 26, 2018

(54) DRIVING FORCE DISTRIBUTION DEVICE FOR VEHICLE

(71) Applicant: TOYOTA JIDOSHA KABUSHIKI KAISHA, Toyota-shi (JP)

(72) Inventors: Takahiro YOSHIMURA, Toyota-shi (JP); Ryota HORIE, Nagoya-shi (JP); Masayuki HASHIMOTO, Nagoya-shi (JP)

(73) Assignee: TOYOTA JIDOSHA KABUSHIKI KAISHA, Toyota-shi (JP)

(21) Appl. No.: 15/874,404

(22) Filed: Jan. 18, 2018

(30) Foreign Application Priority Data
Jan. 20, 2017 (JP) 2017-008982

(51) Int. Cl. B60K 23/08; F16H 48/08; F16H 48/40; F16H 57/037; F16H 57/021; B60K 17/16; F16H 57/022; F16D 11/14

(52) U.S. Cl. CPC B60K 23/08; F16H 48/08; F16H 48/40; F16H 57/037; F16H 2057/127; B60K 17/16; F16H 57/022; F16D 11/14; F16H 2048/405; F16H 57/021

(57) ABSTRACT

Since a gap is formed between a cylindrical member of a second clutch and a differential case so that the differential case is movable relative to the cylindrical member in a rotation-axis-C direction, even if a position of the second clutch relative to a differential carrier is moved by a position adjusting shim, the differential case does not move in the rotation-axis-C direction due to the gap in conjunction with the movement of the position of the second clutch, that is, in conjunction with a movement of a position of the cylindrical member. Accordingly, it possible to largely reduce the number of managing components prepared to eliminate backlash of the rotational member such as the differential case, as compared to the related art.

### INCORPORATION BY REFERENCE

The disclosure of Japanese Patent Application No. 2017-008982 filed on Jan. 20, 2017 including the specification, drawings and abstract is incorporated herein by reference in its entirety.

### BACKGROUND

### 1. Technical Field

The present disclosure relates to a technique to reduce, in comparison with the related art, the number of managing components to be prepared in advance in a vehicle driving force distribution device configured to distribute a driving force transmitted from a drive source to driving wheels via a differential mechanism. The managing components are prepared in advance to eliminate backlash of a differential case or the like at the time when a subassembly in which a connection/disconnection mechanism is assembled is assembled to a main body of the vehicle driving force distribution device in which a differential carrier and a ring gear are integrally assembled. The backlash is caused at the time of adjusting positions, in a rotation-axis direction, of first connection/disconnection teeth of the ring gear and second connection/disconnection teeth of a connection/disconnection sleeve.

### 2. Description of Related Art

There has been known a vehicle driving force distribution device including a differential device having a differential case in which a pair of differential gears are assembled, the vehicle driving force distribution device being configured to distribute a driving force transmitted from a drive source to driving wheels via the differential device. An example of such a vehicle driving force distribution device is a vehicle driving force distribution device described in Japanese Patent Application Publication No. 2016-155502 (JP 2016-155502 A).

The vehicle driving force distribution device of JP 2016-155502 A includes: (a) a differential carrier configured to fix a position of the differential device in the vehicle driving force distribution device so as to support the differential device rotatably around a first axis but immovably along a first-axis direction; (b) a ring gear having first connection/disconnection teeth and supported by the differential carrier rotatably around the first axis but immovably along the first-axis direction; and (c) a connection/disconnection mechanism including a cylindrical member having a cylindrical shape, placed concentrically with a rotation axis of the differential gears, and splined to a shaft insertion portion formed in a first end of the differential case, and a connection/disconnection sleeve having second connection/disconnection teeth and disposed movably relative to the cylindrical member along a rotation-axis direction but non-rotatably relative to the cylindrical member, the connection/disconnection mechanism being configured to connect and disconnect a power transmission path between the ring gear and the differential case by moving the connection/disconnection sleeve along the rotation-axis direction between an engaged position at which the second connection/disconnection teeth of the connection/disconnection sleeve are engaged with the first connection/disconnection teeth of the ring gear and a disengaged position at which the second connection/disconnection teeth of the connection/disconnection sleeve are disengaged from the first connection/disconnection teeth of the ring gear. In the vehicle driving force distribution device of JP 2016-155502 A configured as such, a subassembly, of the vehicle driving force distribution device, in which the connection/disconnection mechanism is assembled therein is assembled to a main body, of the vehicle driving force distribution device, in which the differential carrier and the ring gear are integrally assembled. The vehicle driving force distribution device is provided with a position adjusting shim configured to adjust positions, in the rotation-axis direction, of the first connection/disconnection teeth of the ring gear and the second connection/disconnection teeth of the connection/disconnection sleeve by moving a position of the connection/disconnection mechanism relative to the differential carrier along the rotation-axis direction at the time when the subassembly is assembled to the main body.

### SUMMARY

In the meantime, in the vehicle driving force distribution device as described in JP 2016-155502 A, in order to restrain backlash of a rotational member such as the differential case, the backlash being caused due to a dimension error in manufacture and the like, for example, several types of annular plate materials having an annular shape and having different thickness dimensions are prepared as managing components, for example, and an annular plate material having a thickness to such an extent that the backlash of the rotational member such as the differential case is eliminated, that is, to such an extent that a gap formed around the rotational member such as the differential case is filled is selected and attached. However, in the vehicle driving force distribution device as described in JP 2016-155502 A, the position of the connection/disconnection mechanism relative to the differential carrier is moved along the rotation-axis direction by the position adjusting shim. Accordingly, in conjunction with the movement, the rotational member such as the differential case moves along the rotation-axis direction, so that the position of the connection/disconnection mechanism to be moved by the position adjusting shim affects the backlash of the rotational member such as the differential case, that is, the gap formed around the rotational member such as the differential case. On this account, conventionally, in order that the backlash of the rotational member such as the differential case is eliminated even if the gap formed around the rotational member such as the differential case becomes large at the time when the position of the connection/disconnection mechanism is moved by the position adjusting shim, for example, it is necessary to prepare an annular plate material having a relatively large thickness, which causes a problem that the number of managing components for the annular plate material increases.

The present disclosure reduces the number of managing components prepared to eliminate backlash of a rotational member such as a differential case as compared with the related art.

A first aspect of the present disclosure relates to a driving force distribution device for a vehicle, the driving force distribution device being configured to distribute a driving force transmitted from a drive source to driving wheels. The power distribution device includes: a differential device including a differential case in which a pair of differential gears are assembled; a differential carrier configured to fix the differential device so as to support the differential device rotatably around a first axis but immovably along a first-axis direction; a ring gear including first connection and disconnection teeth and supported by the differential carrier rotatably around the first axis but immovably along the first-axis direction; a connection and disconnection mechanism including a cylindrical member having a cylindrical shape, placed concentrically with a rotation axis of the differential gear, and splined to a shaft insertion portion formed in a first end of the differential case, and a connection and disconnection sleeve including second connection and disconnection teeth and disposed movably along a rotation-axis direction relative to the cylindrical member but non-rotatably relative to the cylindrical member, the connection and disconnection mechanism being configured to connect and disconnect a power transmission path between the ring gear and the differential case by moving the connection and disconnection sleeve in the rotation-axis direction between an engaged position and a disengaged position, the engaged position is a position at which the second connection and disconnection teeth of the connection and disconnection sleeve are engaged with the first connection and disconnection teeth of the ring gear, the disengaged position is a position at which the second connection and disconnection teeth of the connection and disconnection sleeve are disengaged from the first connection and disconnection teeth of the ring gear; a pair of bearing holding members attached to the differential carrier and configured to hold a first bearing and a second bearing supporting both ends of the cylindrical member rotatably around the first axis; an intermediate shaft passing through the cylindrical member and the shaft insertion portion of the differential case and configured such that a first end is connected to one of the differential gears and a second end is connected to a drive shaft in a power transmittable manner; a differential case cover attached to either one of the differential carrier and the bearing holding member so as to support a second end of the differential case; and a position adjusting shim configured to adjust positions, in the rotation-axis direction, between the first connection and disconnection teeth of the ring gear and the second connection and disconnection teeth of the connection and disconnection sleeve by moving a position of the connection and disconnection mechanism relative to the differential carrier in the rotation-axis direction. The cylindrical member of the connection and disconnection mechanism and the differential case have a gap is provided between the cylindrical member and the differential case.

According to the above configuration, since the gap is provided between the cylindrical member of the connection and disconnection mechanism and the differential case, even if the position of the connection and disconnection mechanism relative to the differential carrier is moved by the position adjusting shim, the differential case does not move in the rotation-axis direction due to the gap in conjunction with the movement of the position of the connection and disconnection mechanism, that is, in conjunction with a movement of a position of the cylindrical member. Accordingly, the position of the connection and disconnection mechanism to be moved by the position adjusting shim does not affect backlash of a rotational member such as the differential case, thereby making it possible to largely reduce the number of managing components prepared to eliminate the backlash of the rotational member such as the differential case as compared with the related art.

In the driving force distribution device for the vehicle, the position adjusting shim may be an annular plate material having an annular shape and disposed between one of the pair of the bearing holding members and the first bearing held by the one of the pair of bearing holding members, and the position adjusting shim may be configured to move the position of the connection and disconnection mechanism relative to the differential carrier by moving a position of the cylindrical member relative to the differential carrier along the rotation-axis direction by a thickness of the annular plate material in the rotation-axis direction.

According to the above configuration, by changing the thickness of the annular plate material in the rotation-axis direction, it is possible to preferably adjust the positions, in the rotation-axis direction, of the first connection and disconnection teeth of the ring gear and the second connection and disconnection teeth of the connection and disconnection sleeve at the time when the subassembly is assembled to the main body.

In the driving force distribution device for the vehicle, a first backlash eliminating shim configured to restrain backlash of the cylindrical member with respect to the other one of the pair of bearing holding members may be provided between the other one of the pair of bearing holding members and the second bearing held by the other one of the pair of the bearing holding members.

According to the above configuration, the first backlash eliminating shim can preferably restrain backlash of the cylindrical member with respect to the other one of the pair of bearing holding members to be caused when the position of the cylindrical member of the connection and disconnection mechanism relative to the differential carrier is moved along the rotation-axis direction by the position adjusting shim.

In the driving force distribution device for the vehicle, the other one of the pair of bearing holding members may hold a third bearing supporting the second end of the intermediate shaft rotatably around the rotation axis. A second backlash eliminating shim configured to restrain backlash of the intermediate shaft with respect to the other one of the pair of bearing holding members and backlash of the differential case with respect to the differential case cover may be provided between the other one of the pair of bearing holding members and the third bearing.

According to the above configuration, the second backlash eliminating shim can restrain the backlash of the intermediate shaft with respect to the other one of the pair of bearing holding members and the backlash of the differential case with respect to the differential case cover, thereby making it possible to preferably reduce the number of components of the second backlash eliminating shim as managing components prepared to eliminate the backlash of the differential case and the intermediate shaft.

In the driving force distribution device for the vehicle, the second backlash eliminating shim may be an annular plate material having an annular shape and disposed between the other one of the pair of bearing holding members and the third bearing, and the second backlash eliminating shim may be configured to restrain the backlash of the intermediate shaft with respect to the other one of the pair of bearing holding members and the backlash of the differential case with respect to the differential case cover by moving the intermediate shaft relative to the differential carrier along the rotation-axis direction by a thickness of the annular plate material in the rotation-axis direction.

According to the above configuration, by changing the thickness of the annular plate material in the rotation-axis direction, it is possible to preferably restrain the backlash of the intermediate shaft with respect to the other one of the pair of bearing holding members and the backlash of the differential case with respect to the differential case cover.

In the driving force distribution device for the vehicle, the second backlash eliminating shim may be a coned disc spring disposed in a pressurized state between the other one of the pair of bearing holding members and the third bearing, and the second backlash eliminating shim may be configured to restrain the backlash of the intermediate shaft with respect to the other one of the pair of bearing holding members and the backlash of the differential case with respect to the differential case cover by moving the intermediate shaft relative to the differential carrier along the rotation-axis direction by a biasing force of the coned disc spring.

According to the above configuration, with the use of the coned disc spring as the second backlash eliminating shim, it is possible to restrain the backlash of the intermediate shaft with respect to the other one of the pair of bearing holding members and the backlash of the differential case with respect to the differential case cover, and it is possible to preferably reduce the number of components for the second backlash eliminating shim as managing components provided to eliminate the backlash of the differential case and the intermediate shaft.

In the driving force distribution device for the vehicle, the cylindrical member and the differential case have the gap that may be set based on a thickness of the position adjusting shim such that the cylindrical member and the differential case do not interfere with each other.

In the driving force distribution device for the vehicle, the position adjusting shim may be configured to adjust the positions of the first connection and disconnection teeth and the second connection and disconnection teeth when the cylindrical member, the bearing holding members, and the connection and disconnection sleeve are assembled.

In the driving force distribution device for the vehicle, the first backlash eliminating shim may have a thickness that fills a gap, in the rotation-axis direction, between the other one of the pair of bearing holding members and the second bearing.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an outline view to schematically describe a configuration of a four-wheel drive vehicle to which the present disclosure is preferably applied;

FIG. 2 is a sectional view to describe a configuration of a rear-wheel driving force distribution device provided in the four-wheel drive vehicle in FIG. 1;

FIG. 3A is a schematic view to describe an operating principle of a ratchet mechanism provided in the rear-wheel driving force distribution device in FIG. 2;

FIG. 3B is a schematic view to describe an operating principle of a ratchet mechanism provided in the rear-wheel driving force distribution device in FIG. 2;

FIG. 3C is a schematic view to describe an operating principle of a ratchet mechanism provided in the rear-wheel driving force distribution device in FIG. 2;

FIG. 3D is a schematic view to describe an operating principle of a ratchet mechanism provided in the rear-wheel driving force distribution device in FIG. 2;

FIG. 3E is a schematic view to describe an operating principle of a ratchet mechanism provided in the rear-wheel driving force distribution device in FIG. 2;

FIG. 4 is a sectional view to describe a state where a subassembly of the rear-wheel driving force distribution device is assembled to a main body of the rear-wheel driving force distribution device;

FIG. 5 is a sectional view illustrating a state before a first assembly body of the subassembly is assembled to a second assembly body of the subassembly, in the subassembly of the rear-wheel driving force distribution device in FIG. 4;

FIG. 6 is a sectional view illustrating a state where a differential case in which differential gears and the like assembled and a differential case cover are further assembled to the rear-wheel driving force distribution device in FIG. 4 in which the subassembly is assembled to the main body;

FIG. 7 is an enlarged view illustrating a part of the rear-wheel driving force distribution device in FIG. 2 in an enlarged manner;

FIG. 8 is a sectional view illustrating a part of a rear-wheel driving force distribution device that is not provided with a gap to be formed between a cylindrical member and a differential case so that the differential case is movable relative to the cylindrical member along a rotation-axis direction;

FIG. 9 is a view to describe a rear-wheel driving force distribution device of another embodiment (Embodiment 2) of the present disclosure;

FIG. 10 is a view to describe a rear-wheel driving force distribution device of another embodiment (Embodiment 3) of the present disclosure;

FIG. 11 is a view to describe a rear-wheel driving force distribution device of another embodiment (Embodiment 4) of the present disclosure;

FIG. 12 is a view to describe a rear-wheel driving force distribution device of another embodiment (Embodiment 5) of the present disclosure;

FIG. 13 is a view to describe a rear-wheel driving force distribution device of another embodiment (Embodiment 6) of the present disclosure; and

FIG. 14 is a view to describe a rear-wheel driving force distribution device of another embodiment (Embodiment 7) of the present disclosure.

### DETAILED DESCRIPTION OF EMBODIMENTS

Embodiments of the present disclosure will hereinafter be described in detail with reference to the drawings. Note that the drawings are simplified or modified appropriately in the following embodiments, and a scale ratio, a shape, and the like of each part are not necessarily drawn precisely.

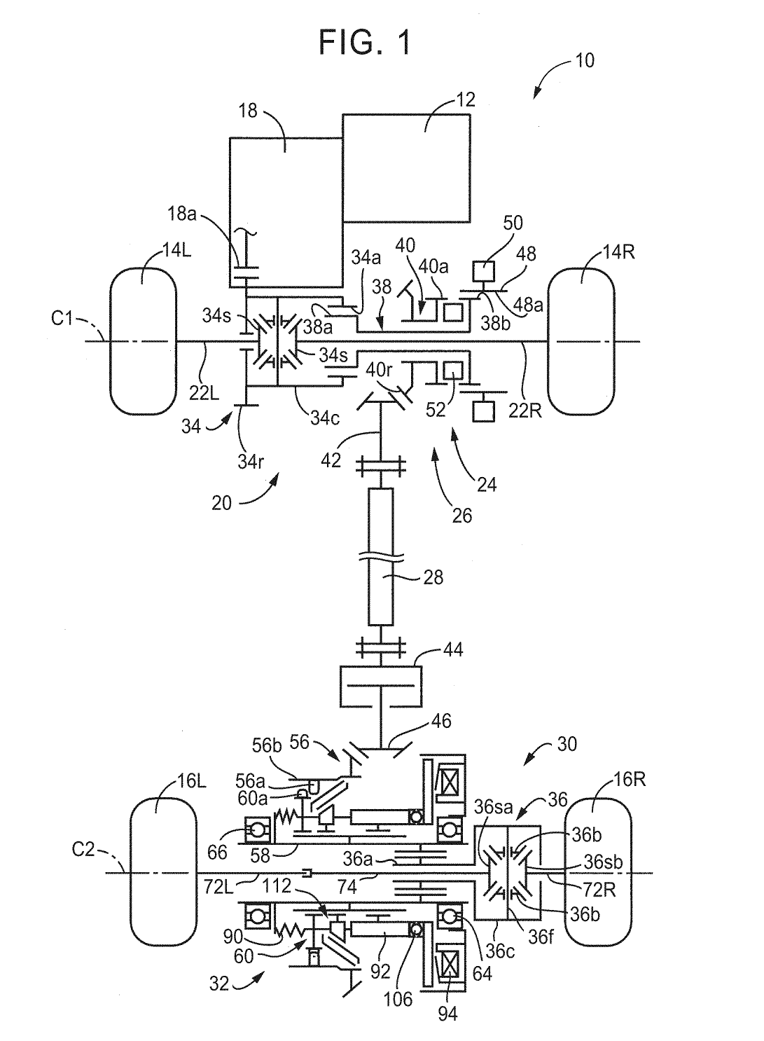

FIG. 1 is an outline view to schematically describe a configuration of a four-wheel drive vehicle 10 to which the present disclosure is preferably applied. In FIG. 1, the four-wheel drive vehicle 10 includes an FF-based four-wheel drive device including: a first power transmission path that uses an engine 12 as a drive source and transmits a power of the engine 12 to left and right front wheels 14L, 14R (just referred to as the front wheels 14 when they are not distinguished in particular) corresponding to primary driving wheels; and a second power transmission path that transmits the power of the engine 12 to left and right rear wheels 16L, 16R (just referred to as the rear wheels 16 when they are not distinguished in particular) corresponding to secondary driving wheels. In a two-wheel-drive state of the four-wheel drive vehicle 10, a driving force transmitted from the engine 12 via an automatic transmission 18 is transmitted to left and right axles 22L, 22R and the left and right front wheels 14L, 14R via a front-wheel driving force distribution device 20. In this two-wheel-drive state, at least a first clutch 24 is released, so that the power is not transmitted to a transfer 26, a propeller shaft 28, a rear-wheel driving force distribution device (a vehicle driving force distribution device) 30, and the rear wheels 16. However, in a four-wheel drive state, in addition to the two-wheel-drive state, the first clutch 24 and a second clutch (a connection/disconnection mechanism) 32 are both engaged, so that the driving force from the engine 12 is transmitted to the transfer 26, the propeller shaft 28, the rear-wheel driving force distribution device 30, and the rear wheels 16. Note that the front-wheel driving force distribution device 20 distributes the driving force transmitted from the engine 12 into the front wheels (driving wheels) 14L, 14R via a first differential device 34 in the two-wheel-drive state and the four-wheel-drive state of the four-wheel drive vehicle 10. Further, the rear-wheel driving force distribution device 30 distributes the driving force transmitted from the engine 12 into the rear wheels (driving wheels) 16L, 16R via a second differential device (a differential mechanism) 36 in the four-wheel-drive state of the four-wheel drive vehicle 10. Although not illustrated in FIG. 1, a torque converter or a clutch as a hydraulic power transmission is provided between the engine 12 and the automatic transmission 18.

The front-wheel driving force distribution device 20 includes a first differential device 34 including: a ring gear 34r provided rotatably around a first rotation axis C1 and engaged with an output gear 18a of the automatic transmission 18; and a differential case 34c integrally fixed to the ring gear 34r and configured such that a pair of differential gears 34s are assembled therein. The first differential device 34 allows respective differential rotations of the left and right axels 22L, 22R of the front wheels 14L, 14R, and transmits the driving force from the engine 12 thereto. Note that inner-peripheral fitting teeth 34a is formed on the differential case 34c such that the inner-peripheral fitting teeth 34a are fitted to outer-peripheral fitting teeth 38a formed in an axial end portion of a first rotational member 38 on a first-differential-device-34 side, the first rotational member 38 being provided in the transfer 26. Hereby, the driving force transmitted from the engine 12 to the front wheels 14L, 14R is partially transmitted from the differential case 34c to the transfer 26.

As illustrated in FIG. 1, the transfer 26 includes the first rotational member 38 on which the outer-peripheral fitting teeth 38a are formed, and a second rotational member 40 in which a ring gear 40r for transmitting a driving force to a rear-wheel-16L, 16R side is integrally formed. Further, in the transfer 26, a power transmission path between the first rotational member 38 and the second rotational member 40 is selectively connected and disconnected by the first clutch 24 constituted by a meshing-engagement dog clutch.

As illustrated in FIG. 1, the first rotational member 38 is a cylindrical member configured such that the axle 22R penetrates through an inner peripheral side thereof, and the first rotational member 38 is provided concentrically with the axle 22R and the second rotational member 40, that is, rotatably around the first rotation axis C1. Further, first clutch teeth 38b constituting a part of the first clutch 24 are formed integrally with an axial end portion of the first rotational member 38 on a side opposite to the first differential device 34.

As illustrated in FIG. 1, the second rotational member 40 is a cylindrical member configured such that the axle 22R and the first rotational member 38 penetrate through an inner peripheral side thereof, and the second rotational member 40 is provided concentrically with the axle 22R and the first rotational member 38, that is, rotatably around the first rotation axis C1. Further, the ring gear 40r engaged with a drive pinion 46 is formed integrally with an axial end portion of the second rotational member 40 on the first-differential-device 34 side, and second clutch teeth 40a constituting a part of the first clutch 24 are formed integrally with an axial end portion of the second rotational member 40 on the side opposite to the first differential device 34. Note that the driven pinion 42 is connected to an end of the propeller shaft 28 on a front-wheel-14 side, and a drive pinion 46 is provided in an end of the propeller shaft 28 on a rear-wheel-16 side via a coupling (a control coupling) 44 that can control a transmission torque by an electronic control unit (not shown).

The first clutch 24 is a meshing clutch to connect/disconnect the first rotational member 38 to/from the second rotational member 40, and is a meshing-engagement dog clutch including: a sleeve 48 having inner-peripheral teeth 48a formed such that the inner-peripheral teeth 48a are always engaged with the first clutch teeth 38b formed in the first rotational member 38 in a relatively movable manner in a first-rotation-axis-C1 direction and are also engageable with the second clutch teeth 40a formed in the second rotational member 40 when the sleeve 48 moves in the first-rotation-axis-C1 direction; and a first actuator 50 configured to drive the sleeve 48 in the first-rotation-axis-C1 direction between a first disengaged position and a first engaged position. Note that the first engaged position is a position where the inner-peripheral teeth 48a of the sleeve 48 are engaged with the second clutch teeth 40a of the second rotational member 40 when the sleeve 48 moves in the first-rotation-axis-C1 direction, and the first disengaged position is a position where the inner-peripheral teeth 48a of the sleeve 48 are disengaged from the second clutch teeth 40a of the second rotational member 40 when the sleeve 48 moves in the first-rotation-axis-C1 direction. Further, the first actuator 50 is constituted by an actuator including an electromagnet and electrically controllable, for example. Further, the first clutch 24 preferably includes a synchronizing linkage 52 configured to decrease a relative rotational difference between the sleeve 48 and the second rotational member 40 at the time when the inner-peripheral teeth 48a of the sleeve 48 are engaged with the second clutch teeth 40a of the second rotational member 40.

FIG. 1 illustrates a state where the first clutch 24 is released.

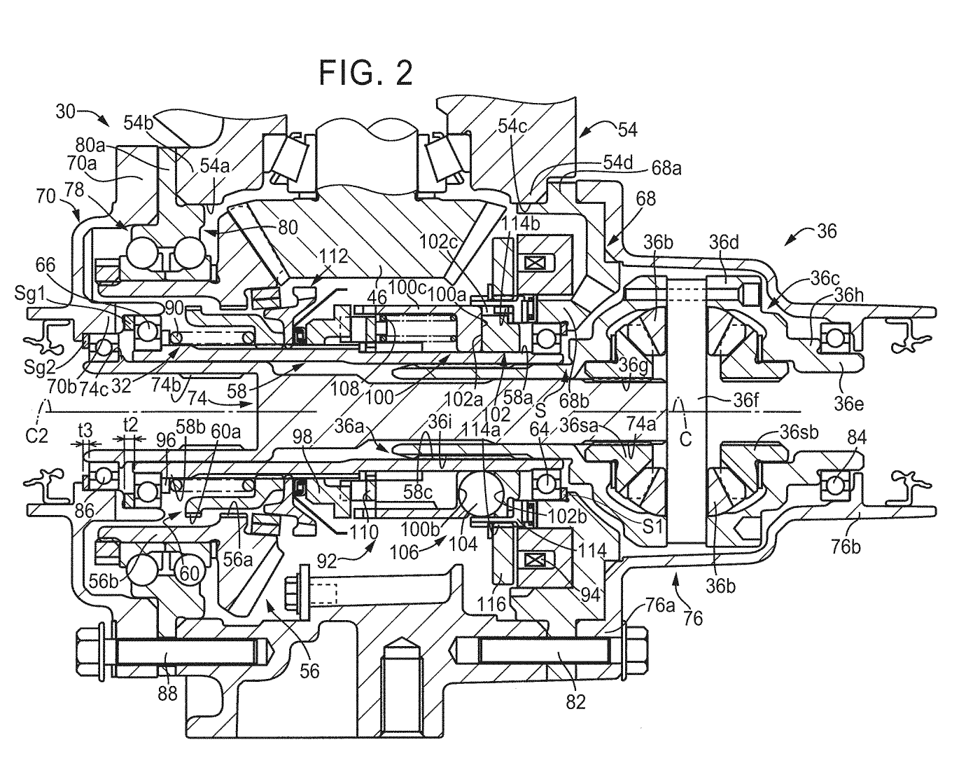

As illustrated in FIGS. 1 and 2, the rear-wheel driving force distribution device 30 includes: a second differential device (a differential device) 36 including a differential case 36c in which a pair of differential gears 36sa, 36sb are assembled; a differential carrier 54 configured to fix a position of the second differential device 36 in the rear-wheel driving force distribution device 30 so as to support the second differential device 36 rotatably around a second rotation axis (a first axis) C2 but immovably along a second-rotation-axis-C2 direction; a cylindrical ring gear 56 having inner-peripheral connection/disconnection teeth (first connection/disconnection teeth) 56a and supported by the differential carrier 54 rotatably around the second rotation axis C2 but immovably along the second-rotation-axis-C2 direction; and a second clutch 32 including a cylindrical member 58 having a cylindrical shape, placed concentrically with a rotation axis C of the differential gears 36sa, 36sb, and splined to a shaft insertion portion 36a formed in an end (a first end) of the differential case 36c on a rear-wheel-16L side, and a connection/disconnection sleeve 60 having outer-peripheral connection/disconnection teeth (second connection/disconnection teeth) 60a and disposed movably relative to the cylindrical member 58 along a rotation-axis-C direction but non-rotatably relative to the cylindrical member 58, the second clutch 32 being a connection/disconnection mechanism configured to connect/disconnect a power transmission path between the ring gear 56 and the differential case 36c by moving the connection/disconnection sleeve 60 in the rotation-axis-C direction between a second engaged position (an engaged position) at which the outer-peripheral connection/disconnection teeth 60a of the connection/disconnection sleeve 60 are engaged with the inner-peripheral connection/disconnection teeth 56a of the ring gear 56 and a second disengaged position (a disengaged position) at which the outer-peripheral connection/disconnection teeth 60a of the connection/disconnection sleeve 60 are disengaged from the inner-peripheral connection/disconnection teeth 56a of the ring gear 56. Note that the rotation axis C and the second rotation axis C2 are concentric with each other.

Further, as illustrated in FIGS. 1 and 2, the rear-wheel driving force distribution device 30 includes: a pair of bearing holding members 68, 70 attached to the differential carrier 54 so as to hold a first bearing 64 and a second bearing 66 configured to support both ends of the cylindrical member 58 rotatably around the second rotation axis C2; an intermediate shaft 74 passing through the cylindrical member 58 and the shaft insertion portion 36a of the differential case 36c, the intermediate shaft 74 being configured such that an end (a first end) thereof on a second-differential-device-36 side is connected to one differential gear 36sa out of the pair of differential gears 36sa, 36sb and an end (a second end) thereof on an opposite side to the second-differential-device-36 side is connected to an axle (a drive shaft) 72L (see FIG. 1) in a power transmittable manner; and a differential case cover 76 indirectly attached to the differential carrier 54 via the bearing holding member 68 so as to support an end (the other end) of the differential case 36c on a rear-wheel-16R side.

As illustrated in FIG. 2, the ring gear 56 is a bevel gear having a hypoid gear, for example, and is configured such that a shaft portion 56b projecting generally cylindrically toward the rear-wheel-16L side from an inner periphery of the ring gear 56 is formed. Further, the cylindrical ring gear 56 is supported in a cantilevered manner so as to be rotatable around the second rotation axis C2 such that the shaft portion 56b of the ring gear 56 is supported by a bearing 78 supported by a peripheral portion 54b of a first opening 54a formed in the differential carrier 54. Note that the bearing 78 includes a projection 80a projecting annularly from an outer ring 80 of the bearing 78 toward an outer peripheral side, and the bearing 78 is supported by the differential carrier 54 such that the projection 80a of the outer ring 80 is supported by the peripheral portion 54b of the differential carrier 54.

As illustrated in FIG. 2, the differential case 36c is integrally provided with: a body portion 36d in which the pair of differential gears 36sa, 36sb and a pair of pinion gears 36b engaged with the pair of differential gears 36sa, 36sb are accommodated; the shaft insertion portion 36a projecting cylindrically from an end of the body portion 36d on the rear-wheel-16L side toward the rear-wheel-16L side; and a projection 36e projecting cylindrically from an end of the body portion 36d on the rear-wheel-16R side toward the rear-wheel-16R side. Note that the differential case 36c is integrally provided with a columnar pinion shaft 36f rotatably supporting the pair of pinion gears 36b. Further, inner-peripheral spline teeth 36g are formed in the differential gear 36sa of the differential case 36c, and outer-peripheral spline teeth 74a formed in an end of the intermediate shaft 74 on the second-differential-device-36 side is fitted, namely, splined to the inner-peripheral spline teeth 36g of the differential gear 36sa. Further, inner-peripheral spline teeth 74b are formed on an inner periphery of an end of the intermediate shaft 74 on the opposite side to the second-differential-device-36 side, and an end (see FIG. 1) of the axle 72L on the second-differential-device-36 side is splined to the inner-peripheral spline teeth 74b of the intermediate shaft 74.

As illustrated in FIG. 2, the bearing holding member 68 includes a first support portion 68a supported by a peripheral portion 54d of a second opening 54c formed in the differential carrier 54, and a second support portion 68b supporting the first bearing 64 press-fitted to an end of the cylindrical member 58 on the second-differential-device-36 side, and the bearing holding member 68 is integrally fixed to the differential carrier 54 with a first fastening bolt 82 (described later). Note that the differential case cover 76 includes: a fixed portion 76a configured to integrally fix the differential case cover 76 to the differential carrier 54 with the first fastening bolt 82 via the bearing holding member 68; and a bearing holding portion 76b configured to hold a bearing 84 provided in the projection 36e of the differential case 36c. Further, the projection 36e of the differential case 36c includes a stopper portion 36h configured to prevent the bearing 84 provided in the projection 36e from moving toward a differential-gear-36sa, 36sb side relative to the projection 36e. Further, a first stopper portion 58a configured to prevent the first bearing 64 provided in the end of the cylindrical member 58 on the second-differential-device-36 side from moving toward an end of the cylindrical member 58 on the opposite side to the second-differential-device-36 side relative to the cylindrical member 58 is formed in an end of the cylindrical member 58 on the second-differential-device-36 side.

As illustrated in FIG. 2, the bearing holding member 70 includes: a first support portion 70a supported by the peripheral portion 54b of the first opening 54a formed in the differential carrier 54 via the projection 80a of the outer ring 80 of the bearing 78; and a second support portion 70b supporting a second bearing 66 press-fitted to the end of the cylindrical member 58 on the opposite side to the second-differential-device-36 side and a bearing (a third bearing) 86 press-fitted to the end of the intermediate shaft 74 on the opposite side to the second-differential-device-36 side. Note that the bearing holding member 70 is integrally fixed to the differential carrier 54 with a second fastening bolt 88 via the projection 80a of the outer ring 80 of the bearing 78. Further, a second stopper portion 58b configured to prevent the second bearing 66 provided in the end of the cylindrical member 58 on the opposite side to the second-differential-device-36 side from moving toward the end of the cylindrical member 58 on the second-differential-device-36 side relative to the cylindrical member 58 is formed in the end of the cylindrical member 58 on the opposite side to the second-differential-device-36 side. Further, an annular stopper portion 74c configured to prevent the bearing 86 provided in the end of the intermediate shaft 74 on the opposite side to the second-differential-device-36 side from moving toward the end of the intermediate shaft 74 on the second-differential-device-36 side is formed in the end of the intermediate shaft 74 on the opposite side to the second-differential-device-36 side.

As illustrated in FIG. 2, the second clutch 32 includes: a first return spring 90 having a coiled shape and configured to bias the connection/disconnection sleeve 60 from the second disengaged position toward the second engaged position; a ratchet mechanism 92 configured to move the connection/disconnection sleeve 60 in the second-rotation-axis-C2 direction so as to move the connection/disconnection sleeve 60 between the second engaged position and the second disengaged position; and an actuator 94 configured to drive the ratchet mechanism 92. Note that the first return spring 90 is provided in a pressurized state between an annular member 96 provided adjacent to the second bearing 66 and the connection/disconnection sleeve 60, so that the connection/disconnection sleeve 60 is biased by the first return spring 90 toward the second-differential-device-36 side in the second-rotation-axis-C2 direction.

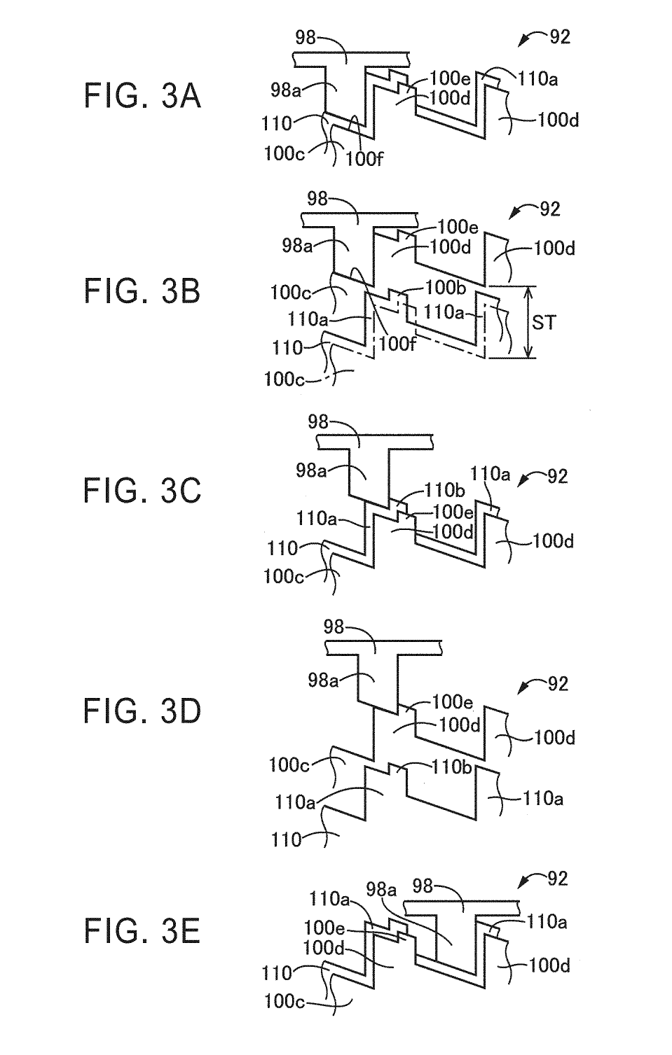

As illustrated in FIG. 2, the ratchet mechanism 92 includes: a piston 98 provided rotatably relative to the cylindrical member 58 around the second rotation axis C2 and configured to move the connection/disconnection sleeve 60 to the second disengaged position against a biasing force of the first return sprint 90; a ball cam 106 including a pair of a first cam 100 and a second cam 102 having an annular shape and configured to rotate relative to each other around the second rotation axis C2 by an operation of the actuator 94, and a spherical rolling element 104 sandwiched between groove-shaped cam surfaces 100b, 102b formed in respective opposed surfaces 100a, 102a of the pair of the first cam 100 and the second cam 102, the opposed surfaces 100a, 102a being opposed to each other, the ball cam 106 being configured such that, when the pair of the first cam 100 and the second cam 102 are rotated relative to each other around the second rotation axis C2, one first cam 100 out of the pair of the first cam 100 and the second cam 102 is moved toward the piston 98; a second return spring 108 configured to bias the first cam 100 toward the second cam 102, namely, to bias the first cam 100 toward the second-differential-device-36 side in the second-rotation-axis-C2 direction; and a holder 110 having latching teeth 110a (see FIG. 3A to FIG. 3E) and provided non-rotatably relative to the cylindrical member 58 around the second rotation axis C2 and immovably along the second-rotation-axis C2, the holder 110 being configured to hook a piston 98 by the latching teeth 110a. Note that, in the ratchet mechanism 92, a synchronizing linkage 112 configured to synchronize a rotation of the cylindrical member 58, namely, the connection/disconnection sleeve 60 with a rotation of the ring gear 56 at the time when the connection/disconnection sleeve 60 moves from the second disengaged position to the second engaged position is disposed between the connection/disconnection sleeve 60 and the piston 98.

As illustrated in FIG. 2, an electromagnetic coil as the actuator 94, and an annular member 114 having an annular shape with an L-shaped section and supported rotatably relative to the bearing holding member 68 around the second rotation axis C2 are assembled to the bearing holding member 68. The annular member 114 is provided with an annular movable piece 116 disposed on an outer peripheral side of the annular member 114 so as to be adjacent to the electromagnetic coil as the actuator 94. Further, outer-peripheral spline teeth 114a engaged with the movable piece 116 so that the movable piece 116 is non-rotatable relative to the annular member 114 but movable relative to the annular member 114 along the second-rotation-axis-C2 direction are formed on an outer periphery of the annular member 114. Further, inner-peripheral spline teeth 114b engaged with outer-peripheral spline teeth 102c formed on an outer periphery of the second cam 102 so that the second cam 102 is non-rotatable relative to the annular member 114 but movable relative to the annular member 114 along the second-rotation-axis-C2 direction are formed on an inner periphery of the annular member 114.

As illustrated in FIG. 2, the ball cam 106 includes: the pair of the first cam 100 and the second cam 102 having an annular shape and inserted between the piston 98 and the first bearing 64 so as to overlap with each other in the second-rotation-axis-C2 direction; and a plurality of (e.g., three) spherical rolling elements 104 sandwiched between groove-shaped cam surfaces 100b, 102b formed at a plurality of (e.g., three) positions in a circumferential direction in the first cam 100 and the second cam 102 so as to be opposed to each other, the groove-shaped cam surfaces 100b, 102b being changed in depth along the circumferential direction. When the first cam 100 and the second cam 102 are rotated relative to each other, the first cam 100 and the second cam 102 are separated from each other in the second-rotation-axis-C2 direction. Note that, although not illustrated herein, inner-peripheral engagement teeth are formed on an inner peripheral surface of the first cam 100 so as to be engaged with outer-peripheral spline teeth formed on the cylindrical member 58 non-rotatably relative to the cylindrical member 58 but movably along the second-rotation-axis-C2 direction. Hereby, when the cylindrical member 58 rotates around the second rotation axis C2, for example, the first cam 100 also rotates around the second rotation axis C2, and in a case where the actuator 94 does not operate, for example, the second cam 102 rotates integrally with the first cam 100 via the spherical rolling elements 104.

In the electromagnetic coil as the actuator 94, the ball cam 106, the annular member 114, and the movable piece 116 configured as described above, for example, in a state where the cylindrical member 58 rotates around the second rotation axis C2 during vehicle-running, when the actuator 94 operates so that the movable piece 116 is adsorbed to the electromagnetic coil due to the electromagnetic coil, a rotation braking torque is transmitted to the second cam 102 via the annular member 114 due to the movable piece 116 being adsorbed to the electromagnetic coil, which is a nonrotatable member. On this account, the first cam 100 and the second cam 102 rotate relative to each other due to the rotation braking torque, so that the first cam 100 moves toward the piston 98 along the second-rotation-axis-C2 direction via the spherical rolling elements 104 against biasing forces of the first return spring 90 and the second return spring 108, and the connection/disconnection sleeve 60 is moved toward the rear-wheel-16L side via the piston 98 and the like. Further, when the actuator 94 is shifted to a non-operation state from an operation state, the connection/disconnection sleeve 60 is moved toward the rear-wheel-16R side by the biasing force of the first return spring 90, and the first cam 100 moves in a direction to approach the second cam 102 by the biasing force of the second return spring 108.

FIG. 3A to FIG. 3E are a schematic view to describe an operating principle of the ratchet mechanism 92, and illustrates a developed state of the annular piston 98, a pressing portion 100c of the annular first cam 100, and the annular holder 110. As illustrated in FIG. 3A to FIG. 3E, a protrusion 98a protruding toward a holder-110 side is formed in the annular piston 98. Further, the annular holder 110 includes the latching teeth 110a having a saw-teeth shape and formed periodically continuous with each other in a circumferential direction so that the protrusion 98a of the piston 98 is hooked thereto, and the holder 110 is fixedly disposed in the cylindrical member 58. Further, the pressing portion 100c of the annular first cam 100 includes stop teeth 100d having a saw-teeth shape like the latching teeth 110a of the holder 110 and formed periodically continuous with each other in the circumferential direction in such a manner that they are displaced at a predetermined phase in the circumferential direction, the stop teeth 100d being configured to receive the protrusion 98a of the piston 98. The pressing portion 100c of the annular first cam 100 is provided non-rotatably relative to the holder 110 but movably along the second-rotation-axis-C2 direction, and can move the piston 98 by one stroke of the ball cam 106 against the biasing forces of the first return spring 90 and the second return spring 108. Note that stoppers 100e and 110b configured to prevent slips of the protrusion 98a of the piston 98 are provided on inclined surfaces of respective tip ends of the stop teeth 100d of the pressing portion 100c of the first cam 100 and the latching teeth 110a of the holder 110.

FIG. 3A and FIG. 3E illustrate a state where the connection/disconnection sleeve 60 is placed at the second engaged position. As illustrated in FIG. 3 A and FIG. 3E, in a state where the protrusion 98a protruding from the piston 98 is placed at a position where the protrusion 98a is hooked to the latching tooth 110a of the holder 110, the pressing portion 100c of the first cam 100 is placed at its base position. FIG. 3B illustrates a state where the piston 98 is moved from the base position against the biasing forces of the first return spring 90 and the second return spring 108 only by a movement stroke ST due to driving of the ball cam 106 by current application to the electromagnet as the actuator 94. In this course, the piston 98 is moved by the pressing portion 100c of the first cam 100 so as to be separated from the holder 110, and the piston 98 slides from an inclined surface 100f of the pressing portion 100c of the first cam 100. Note that an alternate long and short dash line illustrated in FIG. 3B indicates the base position of the pressing portion 100c of the first cam 100 in FIG. 3A so as to describe the movement stroke ST. FIG. 3C illustrates a state where the pressing portion 100c of the first cam 100 is returned only by the movement stroke ST to be placed at the base position, in accordance with the biasing force of the second return spring 108 due to non-driving of the ball cam 106 by non-current application to the electromagnet as the actuator 94. In this course, the piston 98 is hooked to the latching tooth 110a of the holder 110, and held at the second disengaged position. FIG. 3D illustrates a state where the pressing portion 100c of the first cam 100 is moved again from the base position against the biasing forces of the first return spring 90 and the second return spring 108 only by the movement stroke ST due to driving of the ball cam 106 by current application to the electromagnet as the actuator 94. In this course, the piston 98 is further moved toward a first-return-spring 90 side, so that a rotation of the ring gear 56 is synchronized with a rotation of the connection/disconnection sleeve 60 by the synchronizing linkage 112. Subsequently, as illustrated in FIG. 3E, when the pressing portion 100c of the first cam 100 is returned only by the movement stroke ST to be placed at the base position, in accordance with the biasing force of the second return spring 108 due to non-driving of the ball cam 106 by non-current application to the electromagnet as the actuator 94, the connection/disconnection sleeve 60 is placed at the second engaged position.

Hereby, in the ratchet mechanism 92, the piston 98 is sent in the circumferential direction by reciprocation of the first cam 100 by the ball cam 106, so that the connection/disconnection sleeve 60 can be moved toward the second disengaged position and the second engaged position. That is, when the piston 98 reciprocates once by the first cam 100, the connection/disconnection sleeve 60 is placed at the second disengaged position. When the piston 98 reciprocates twice by the first cam 100, that is, when the piston 98 further reciprocates once by the first cam 100 in a state where the connection/disconnection sleeve 60 is placed at the second disengaged position, the piston 98 is taken off from the latching teeth 110a of the holder 110, so that the connection/disconnection sleeve 60 is placed at the second engaged position due to the biasing force of the first return spring 90.

In the four-wheel drive vehicle 10 configured as described above, when a two-wheel drive running mode is selected by an electronic control unit (not shown) in a four-wheel drive state where the first clutch 24 and the second clutch 32 are both engaged, for example, the sleeve 48 is moved to the first disengaged position by the first actuator 50 so that the first clutch 24 is released, and the connection/disconnection sleeve 60 is moved to the second disengaged position by the actuator 94 in the rear-wheel driving force distribution device 30 so that the second clutch 32 is released, thereby establishing a two-wheel-drive state in which a driving force is transmitted from the engine 12 only to the front wheels 14 as the primary driving wheels. Further, in the two-wheel-drive state where the first clutch 24 and the second clutch 32 are both released, that is, in a disconnected state where a power transmission path between the engine 12 and the propeller shaft 28 and a power transmission path between the rear wheels 16 and the propeller shaft 28 are both separated, when a four-wheel drive running mode is selected by the electronic control unit (not shown), the sleeve 48 is moved to the first engaged position by the first actuator 50 so that the first clutch 24 is engaged, for example, and after the engagement of the first clutch 24, the connection/disconnection sleeve 60 is moved to the second engaged position by the actuator 94 so that the second clutch 32 is engaged, and hereby the disconnected state is cancelled.

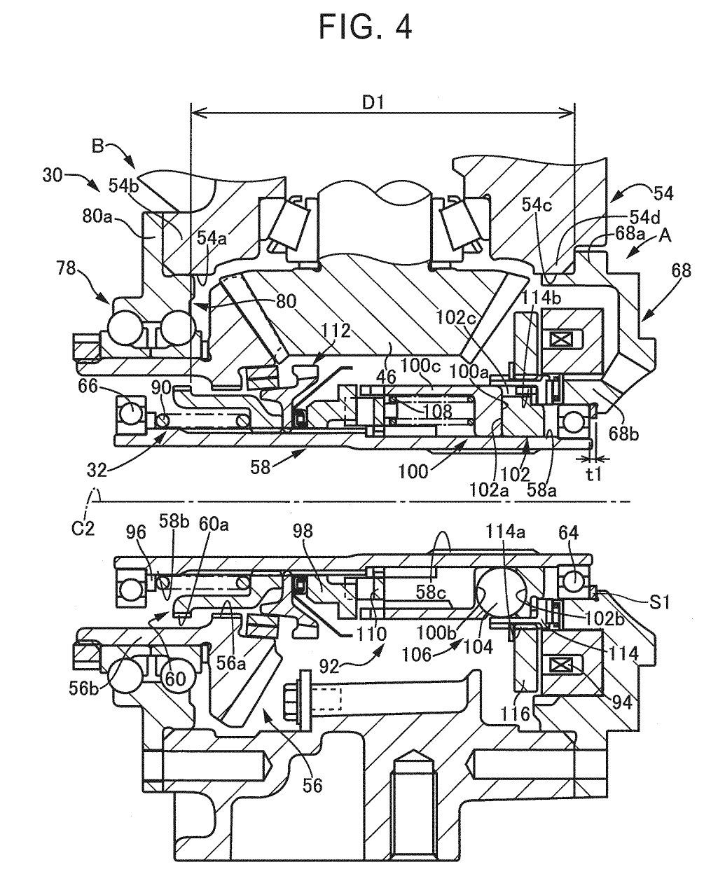

As illustrated in FIG. 4, in the rear-wheel driving force distribution device 30, a subassembly A of the rear-wheel driving force distribution device 30 in which the second clutch 32, the first bearing 64, the second bearing 66, the bearing holding member 68, and so on are assembled integrally, for example, is assembled to a main body B of the rear-wheel driving force distribution device 30 in which the differential carrier 54, the ring gear 56, the bearing 78, the drive pinion 46, and so on are assembled integrally, for example. Further, the subassembly A of the rear-wheel driving force distribution device 30 is provided with a position adjusting shim S1 configured to adjust positions, in the second-rotation-axis-C2 direction, of the inner-peripheral connection/disconnection teeth 56a of the ring gear 56 and the outer-peripheral connection/disconnection teeth 60a of the connection/disconnection sleeve 60 by moving a position of the cylindrical member 58 of the second clutch 32 relative to the differential carrier 54 along the second-rotation-axis-C2 direction at the time when the subassembly A is assembled to the main body B.

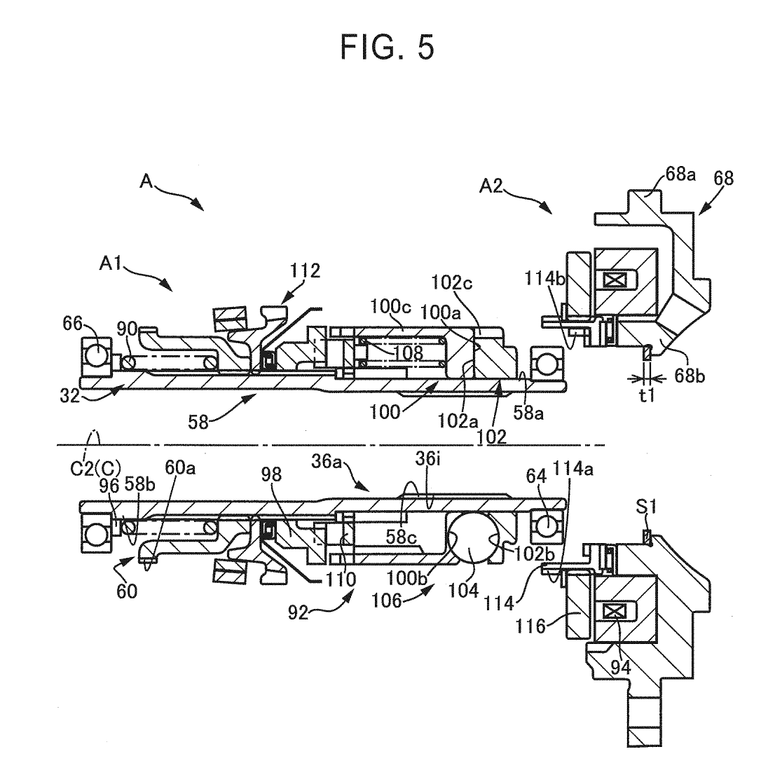

As illustrated in FIG. 5, the subassembly A includes: a cylindrical first assembly body A1 in which the cylindrical member 58, the connection/disconnection sleeve 60, the first bearing 64, the second bearing 66, the ratchet mechanism 92, the first return spring 90, and so on are assembled integrally, for example; and an annular second assembly body A2 in which the bearing holding member 68, the actuator 94, the annular member 114, the movable piece 116, and so on are assembled integrally, for example. When the inner-peripheral spline teeth 114b formed on the annular member 114 assembled in the second assembly body A2 is fitted, namely, splined to the outer-peripheral spline teeth 102c formed on the second cam 102 assembled in the first assembly body A1, the second assembly body A2 is assembled to the first assembly body A1.

As illustrated in FIG. 5, the position adjusting shim S1 is an annular plate material disposed between the second support portion 68b of the bearing holding member 68 and the first bearing 64 press-fitted to the end of the cylindrical member 58 on the second-differential-device-36 side. Further, for the position adjusting shim S1, several types of annular plate materials having respective thicknesses t1 in the second-rotation-axis-C2 direction, which differ by 0.1 mm, for example, are prepared as managing components. When an annular plate material is selected from the several types of the annular plate materials thus prepared and is disposed between the second support portion 68b of the bearing holding member 68 and the first bearing 64 press-fitted to the end of the cylindrical member 58 on the second-differential-device-36 side, a position of the cylindrical member 58 relative to the differential carrier 54, namely, a position of the connection/disconnection sleeve 60 provided in the cylindrical member 58 relative to the bearing holding member 68 supported by the differential carrier 54 is moved along the second rotation-axis-C2 direction, so as to move a position of the second clutch 32 relative to the differential carrier 54. That is, by changing the thickness t1 of the annular plate material as the position adjusting shim S1, a distance D1 (illustrated in FIG. 4) between the first support portion 68a of the bearing holding member 68 supported by the differential carrier 54 and the outer-peripheral connection/disconnection teeth 60a of the connection/disconnection sleeve 60 provided in the cylindrical member 58 is changed, thereby adjusting the positions, in the second-rotation-axis-C2 direction, of the inner-peripheral connection/disconnection teeth 56a of the ring gear 56 and the outer-peripheral connection/disconnection teeth 60a of the connection/disconnection sleeve 60 at the time when the subassembly A of the rear-wheel driving force distribution device 30 is assembled to the main body B of the rear-wheel driving force distribution device 30.

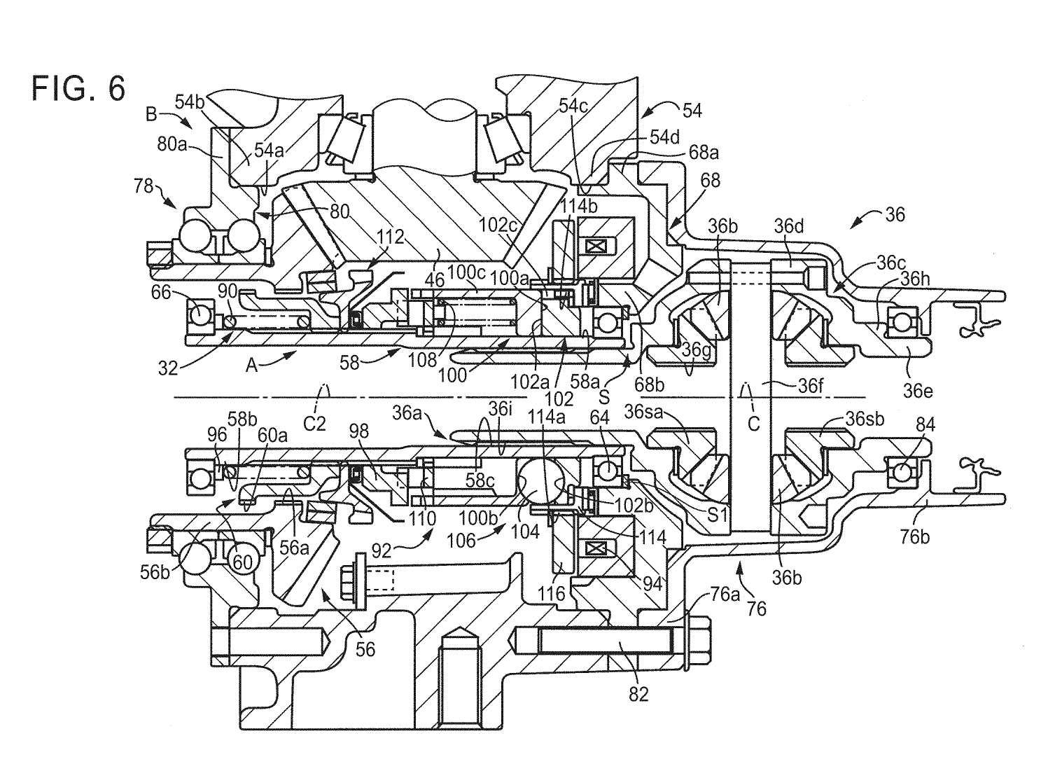

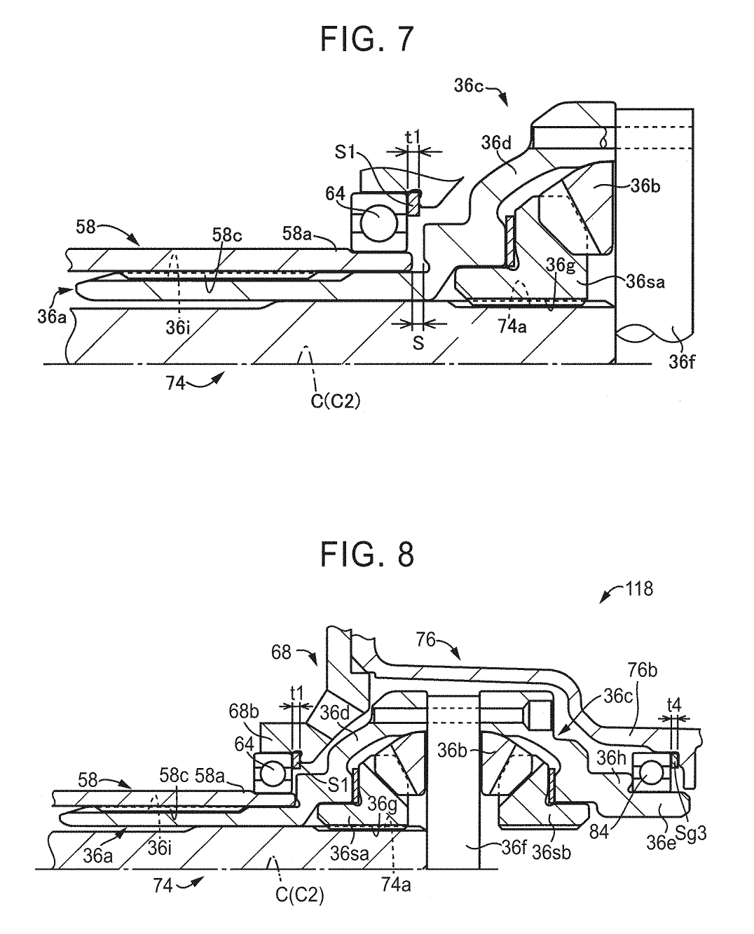

FIG. 6 is a view illustrating a state where the differential case 36c in which the differential gears 36sa, 36sb, the pinion gears 36b, and so on are assembled and the differential case cover 76 are further assembled in the rear-wheel driving force distribution device 30 illustrated in FIG. 4 in which the subassembly A is assembled to the main body B. As illustrated in FIG. 6, in a state where the differential case 36c is assembled in the rear-wheel driving force distribution device 30 such that outer-peripheral spline teeth 36i formed on an outer periphery of the shaft insertion portion 36a of the differential case 36c are fitted, namely, splined to inner-peripheral spline teeth 58c formed on an inner periphery of the end of the cylindrical member 58 on the second-differential-device-36 side, a gap S set to prevent the differential case 36c from interfering with the cylindrical member 58 even if the thickness t1 of the position adjusting shim S1 is changed in an assembling course is formed between the end of the cylindrical member 58 of the second clutch 32 on the second-differential-device-36 side and the end of the body portion 36d of the differential case 36c on the first-bearing-64 side, as specifically illustrated in FIG. 7.

Further, as illustrated in FIG. 2, a first backlash eliminating shim Sg1 configured to restrain backlash of the cylindrical member 58 relative to the bearing holding member 70, that is, to fill a gap in the second-rotation-axis-C2 direction between the second support portion 70b of the bearing holding member 70 and the second bearing 66 press-fitted to the end of the cylindrical member 58 is provided between the second support portion 70b of the bearing holding member 70 and the second bearing 66 press-fitted to the end of the cylindrical member 58 on the opposite side to the second-differential-device-36 side. Note that, as illustrated in FIG. 2, the first backlash eliminating shim Sg1 is an annular plate material disposed between the second support portion 70b of the bearing holding member 70 and the second bearing 66 press-fitted to the end of the cylindrical member 58. Further, for the first backlash eliminating shim Sg1, several types of annular plate materials having respective thicknesses t2 in the second-rotation-axis-C2 direction, which differ by 0.1 mm, for example, are prepared as managing components. An annular plate material having a thickness t2 that fills the gap in the second-rotation-axis-C2 direction between the second support portion 70b of the bearing holding member 70 and the second bearing 66 press-fitted to the end of cylindrical member 58 is selected from the several types of the annular plate materials having different thicknesses t2 in the second-rotation-axis-C2 direction and the annular plate material thus selected is disposed between the second support portion 70b of the bearing holding member 70 and the second bearing 66 press-fitted to the end of the cylindrical member 58.

Further, as illustrated in FIG. 2, a second backlash eliminating shim Sg2 is provided between the second support portion 70b of the bearing holding member 70 and the bearing 86 press-fitted to the end of the intermediate shaft 74 on the second-differential-device-36 side. The second backlash eliminating shim Sg2 is configured to restrain backlash of the intermediate shaft 74 with respect to the bearing holding member 70 and backlash of the differential case 36c with respect to the differential case cover 76, that is, to fill a gap in the second-rotation-axis-C2 direction between the second support portion 70b of the bearing holding member 70 and the bearing 86 press-fitted to the end of the intermediate shaft 74 and a gap in the second-rotation-axis-C2 direction between the bearing holding portion 76b of the differential case cover 76 and the bearing 84 press-fitted to the projection 36e of the differential case 36c. Note that, as illustrated in FIG. 2, the second backlash eliminating shim Sg2 is an annular plate material disposed between the second support portion 70b of the bearing holding member 70 and the bearing 86 press-fitted to the end of the intermediate shaft 74 on the opposite side to the second-differential-device-36 side. Further, for the second backlash eliminating shim Sg2, several types of annular plate materials having respective thicknesses t3 in the second-rotation-axis-C2 direction, which differ by 0.1 mm, for example, are prepared as managing components. An annular plate material having a thickness t3 that fills the gap in the second-rotation-axis-C2 direction between the second support portion 70b of the bearing holding member 70 and the bearing 86 press-fitted to the end of the intermediate shaft 74 and the gap in the second-rotation-axis-C2 direction between the bearing holding portion 76b of the differential case cover 76 and the bearing 84 press-fitted to the projection 36e of the differential case 36c is selected from the several types of the annular plate materials having different thicknesses t3 in the second-rotation-axis-C2 direction, and the annular plate material thus selected is disposed between the second support portion 70b of the bearing holding member 70 and the bearing 86 press-fitted to the end of the intermediate shaft 74.

Note that, as illustrated in FIG. 2, when the annular plate material as the second backlash filling shim Sg2 is disposed between the second support portion 70b of the bearing holding member 70 and the bearing 86 press-fitted to the end of the intermediate shaft 74, the end of the intermediate shaft 74 on the second-differential-device-36 side moves toward the pinion-shaft-36f side in the second-rotation-axis-C2 direction so as to abut with the pinion shaft 36f, so that the differential case 36c in which the pinion shaft 36f is secured moves toward a differential-case-cover-76 side in the second-rotation-axis-C2 direction. Hereby, the gap in the second-rotation-axis-C2 direction between the bearing 84 press-fitted to the projection 36e of the differential case 36c and the bearing holding portion 76b of the differential case cover 76 is filled, thereby making it possible to restrain backlash of the differential case 36c with respect to the differential case cover 76. That is, when the second backlash eliminating shim Sg2 fills the gap in the second-rotation-axis-C2 direction between the second support portion 70b of the bearing holding member 70 and the bearing 86 press-fitted to the end of the intermediate shaft 74, so that backlash of the intermediate shaft 74 with respect to the bearing holding member 70 is restrained, the differential case 36c in which the pinion shaft 36f is secured is moved by the intermediate shaft 74 in the second-rotation-axis-C2 direction, so that the gap in the second-rotation-axis-C2 direction between the bearing holding portion 76b of the differential case cover 76 and the bearing 84 press-fitted to the projection 36e of the differential case 36c is filled, thereby restraining the backlash of the differential case 36c with respect to the differential case cover 76.

FIG. 8 is a view illustrating a part of a rear-wheel driving force distribution device 118 that is not provided with a gap S as illustrated in FIG. 2 to be formed between a cylindrical member 58 and a differential case 36c so that the differential case 36c is movable relative to the cylindrical member 58 in a second-rotation-axis-C2 direction. Note that, in the rear-wheel driving force distribution device 118, a part common to the rear-wheel driving force distribution device 30 has the same reference sign and is not described herein. In the rear-wheel driving force distribution device 118 as illustrated in FIG. 8, a third backlash eliminating shim Sg3 is provided between a bearing holding portion 76b of a differential case cover 76 and a bearing 84 press-fitted to a projection 36e of the differential case 36c. The third backlash eliminating shim Sg3 is configured to restrain backlash of the differential case 36c with respect to the differential case cover 76, that is, to fill a gap in the second-rotation-axis-C2 direction between the bearing holding portion 76b of the differential case cover 76 and the bearing 84 press-fitted to the projection 36e of the differential case 36c. Note that, in the rear-wheel driving force distribution device 118, a second backlash eliminating shim Sg2 as described above is provided to restrain backlash of an intermediate shaft 74 with respect to a bearing holding member 70, that is, to fill a gap in the second-rotation-axis-C2 direction between a second support portion 70b of the bearing holding member 70 and a bearing 86 press-fitted to an end of the intermediate shaft 74.

As illustrated in FIG. 8, the third backlash eliminating shim Sg3 is an annular plate material press-fitted between the bearing holding portion 76b of the differential case cover 76 and the bearing 84 press-fitted to the projection 36e of the differential case 36c. Further, for the third backlash eliminating shim Sg3, annular plate materials having respective thicknesses t4 in the second-rotation-axis-C2 direction, which differ by 0.1 mm, for example, are prepared as managing components. An annular plate material having a thickness t4 that fills the gap between the bearing holding portion 76b of the differential case cover 76 and the bearing 84 press-fitted to the projection 36e of the differential case 36c is selected from several types of annular plate materials having different thicknesses t4 in the second-rotation-axis-C2 direction, and the annular plate material thus selected is disposed between the bearing holding portion 76b of the differential case cover 76 and the bearing 84 press-fitted to the projection 36e of the differential case 36c. Note that, when the third backlash eliminating shim Sg3 fills the gap in the second-rotation-axis-C2 direction between the bearing holding portion 76b of the differential case cover 76 and the bearing 84 press-fitted to the projection 36e of the differential case 36c, an end of a body portion 36d of the differential case 36c on a cylindrical-member-58 side abuts with an end of the cylindrical member 58 on a second-differential-device-36 side, as illustrated in FIG. 8.

In the rear-wheel driving force distribution device 118 configured as such, when a position of a second clutch 32, namely, the cylindrical member 58 relative to a differential carrier 54 is moved along the second-rotation-axis-C2 direction by a position adjusting shim S1, the differential case 36c abutting with the end of the cylindrical member 58 on the second-differential-device-36 side moves relative to the differential case cover 76 in the second-rotation-axis-C2 direction in conjunction with the movement of the cylindrical member 58 along the second-rotation-axis-C2 direction, and the intermediate shaft 74 abutting with a pinion shaft 36f secured in the differential case 36c moves relative to the bearing holding member 70 along the second-rotation-axis-C2 direction. That is, when the position of the cylindrical member 58 relative to the differential carrier 54 is moved along the second-rotation-axis-C2 direction by the position adjusting shim S1, this movement affects the gap in the second-rotation-axis-C2 direction between the bearing holding portion 76b of the differential case cover 76 and the bearing 84 press-fitted to the projection 36e of the differential case 36c and the gap in the second-rotation-axis-C2 direction between the second support portion 70b of the bearing holding member 70 and the bearing 86 press-fitted to the end of the intermediate shaft 74. Accordingly, it is necessary to prepare annular plate materials having relatively large thicknesses t3, t4 as managing components in the rear-wheel driving force distribution device 118, so that backlash of the differential case 36c and the intermediate shaft 74 can be eliminated even if the position of the cylindrical member 58 relative to the differential carrier 54 is moved by the position adjusting shim S1 so as to increase the gap in the second-rotation-axis-C2 direction between the bearing holding portion 76b of the differential case cover 76 and the bearing 84 press-fitted to the projection 36e of the differential case 36c and the gap in the second-rotation-axis-C2 direction between the second support portion 70b of the bearing holding member 70 and the bearing 86 press-fitted to the end of the intermediate shaft 74.

As described above, the rear-wheel driving force distribution device 30 of the present embodiment includes: the differential carrier 54 configured to fix the position of the second differential device 36 in the rear-wheel driving force distribution device 30 so as to support the second differential device 36 rotatably around the second rotation axis C2 but immovably along the second-rotation-axis-C2 direction; the cylindrical ring gear 56 having the inner-peripheral connection/disconnection teeth 56a and supported by the differential carrier 54 rotatably around the second rotation axis C2 but immovably along the second-rotation-axis-C2 direction; the second clutch 32 including the cylindrical member 58 having a cylindrical shape, placed concentrically with the second rotation axis C2 of the differential gears 36sa, 36sb, and splined to the shaft insertion portion 36a formed in a first end of the differential case 36c, and the connection/disconnection sleeve 60 having the outer-peripheral connection/disconnection teeth 60a and disposed movably along the second-rotation-axis-C2 direction relative to the cylindrical member 58 but non-rotatably relative to the cylindrical member 58, the second clutch 32 being configured to connect and disconnect the power transmission path between the ring gear 56 and the differential case 36c by moving the connection/disconnection sleeve 60 in the second-rotation-axis-C2 direction between the second engaged position at which the outer-peripheral connection/disconnection teeth 60a of the connection/disconnection sleeve 60 are engaged with the inner-peripheral connection/disconnection teeth 56a of the ring gear 56 and a second disengaged position at which the outer-peripheral connection/disconnection teeth 60a of the connection/disconnection sleeve 60 are disengaged from the inner-peripheral connection/disconnection teeth 56a of the ring gear 56; the pair of bearing holding members 68, 70 attached to the differential carrier 54 so as to hold the first bearing 64 and the second bearing 66 configured to support both ends of the cylindrical member 58 rotatably around the second rotation axis C2; the intermediate shaft 74 passing through the cylindrical member 58 and the shaft insertion portion 36a of the differential case 36c and configured such that a first end is connected to the differential gear 36sa and a second end is connected to the axle 72L in a power transmittable manner; and the differential case cover 76 indirectly attached to the differential carrier 54 so as to support the second end of the differential case 36c. In the rear-wheel driving force distribution device 30, the subassembly A of the rear-wheel driving force distribution device 30 in which the second clutch 32 and so on are assembled is assembled to the main body B of the rear-wheel driving force distribution device 30 in which the differential carrier 54, the ring gear 56, and so on are integrally assembled. The rear-wheel driving force distribution device 30 is provided with the position adjusting shim S1 configured to adjust the positions, in the rotation-axis-C direction, of the inner-peripheral connection/disconnection teeth 56a of the ring gear 56 and the outer-peripheral connection/disconnection teeth 60a of the connection/disconnection sleeve 60 by moving the position of the second clutch 32 relative to the differential carrier 54 along the rotation-axis-C direction at the time when the subassembly A is assembled to the main body B. The gap S is provided between the cylindrical member 58 of the second clutch 32 and the differential case 36c so that the differential case 36c is movable relative to the cylindrical member 58 along the second-rotation-axis-C2 direction. Accordingly, since the gap S is formed between the cylindrical member 58 of the second clutch 32 and the differential case 36c so that the differential case 36c is movable relative to the cylindrical member 58 along the second-rotation-axis-C2 direction, even if the position of the second clutch 32 relative to the differential carrier 54 is moved by the position adjusting shim S1, the differential case 36c does not move in the second-rotation-axis-C2 direction due to the gap S in conjunction with the movement of the position of the second clutch 32, that is, in conjunction with the movement of the position of the cylindrical member 58. Thus, the position of the second clutch 32 to be moved by the position adjusting shim S1 does not affect backlash of the rotational member such as the differential case 36c, thereby making it possible to largely reduce the number of managing components prepared to eliminate the backlash of the rotational member such as the differential case 36c, as compared with a conventional example, e.g., the rear-wheel driving force distribution device 118 illustrated in FIG. 8.

Further, in the rear-wheel driving force distribution device 30 of the present embodiment, the position adjusting shim S1 is an annular plate material having an annular shape and disposed between the bearing holding member 68 and the first bearing 64 held by the bearing holding member 68, and the position of the cylindrical member 58 relative to the differential carrier 54 is moved along the second-rotation-axis-C2 direction by the thickness t1 of the annular plate material in the second-rotation-axis-C2 direction, so as to move the position of the second clutch 32 relative to the differential carrier 54. On this account, by changing the thickness t1 of the annular plate material in the second-rotation-axis-C2 direction, it is possible to preferably adjust the positions, in the second-rotation-axis-C2 direction, of the inner-peripheral connection/disconnection teeth 56a of the ring gear 56 and the outer-peripheral connection/disconnection teeth 60a of the connection/disconnection sleeve 60 at the time when the subassembly A is assembled to the main body B.

Further, in the rear-wheel driving force distribution device 30 of the present embodiment, the first backlash eliminating shim Sg1 is provided between the bearing holding member 70 and the second bearing 66 held by the bearing holding member 70 so as to restrain backlash of the cylindrical member 58 with respect to the bearing holding member 70. Hereby, the first backlash eliminating shim Sg1 can preferably restrain backlash of the cylindrical member 58 relative to the bearing holding member 70 to be caused when the position of the cylindrical member 58 of the second clutch 32 relative to the differential carrier 54 is moved along the second-rotation-axis-C2 direction by the position adjusting shim S1.

Further, in the rear-wheel driving force distribution device 30 of the present embodiment, the bearing holding member 70 holds the bearing 86 supporting the other end of the intermediate shaft 74 rotatably around the second rotation axis C2, and the second backlash eliminating shim Sg2 is provided between the bearing holding member 70 and the bearing 86 so as to restrain backlash of the intermediate shaft 74 with respect to the bearing holding member 70, and backlash of the differential case 36c with respect to the differential case cover 76. Hereby, the second backlash eliminating shim Sg2 can restrain the backlash of the intermediate shaft 74 with respect to the bearing holding member 70 and the backlash of the differential case 36c with respect to the differential case cover 76, thereby making it possible to preferably reduce the number of managing components prepared to eliminate the backlash of the differential case 36c and the intermediate shaft 74.

Further, in the rear-wheel driving force distribution device 30 of the present embodiment, the second backlash eliminating shim Sg2 is an annular plate material having an annular shape and disposed between the bearing holding member 70 and the bearing 86, and the intermediate shaft 74 is moved relative to the differential carrier 54 along the second-rotation-axis-C2 direction by the thickness t3 of the annular plate material in the second-rotation-axis-C2 direction, so as to restrain the backlash of the intermediate shaft 74 with respect to the bearing holding member 70 and the backlash of the differential case 36c with respect to the differential case cover 76. On this account, by changing the thickness t3 of the annular plate material in the second-rotation-axis-C2 direction, it is possible to preferably restrain the backlash of the intermediate shaft 74 with respect to the bearing holding member 70 and the backlash of the differential case 36c with respect to the differential case cover 76.

Further, in the rear-wheel driving force distribution device 30 of the present embodiment, the gap S is larger than a change range of the thickness t1 of the position adjusting shim S1. Accordingly, even if the position of the second clutch 32 relative to the differential carrier 54 is moved by the position adjusting shim S1, the differential case 36c does not move in the second-rotation-axis-C2 direction in conjunction with the movement of the position of the cylindrical member 58.

Next will be described other embodiments of the present disclosure. Note that a part common to Embodiment 1 has the same reference sign and is not described herein.

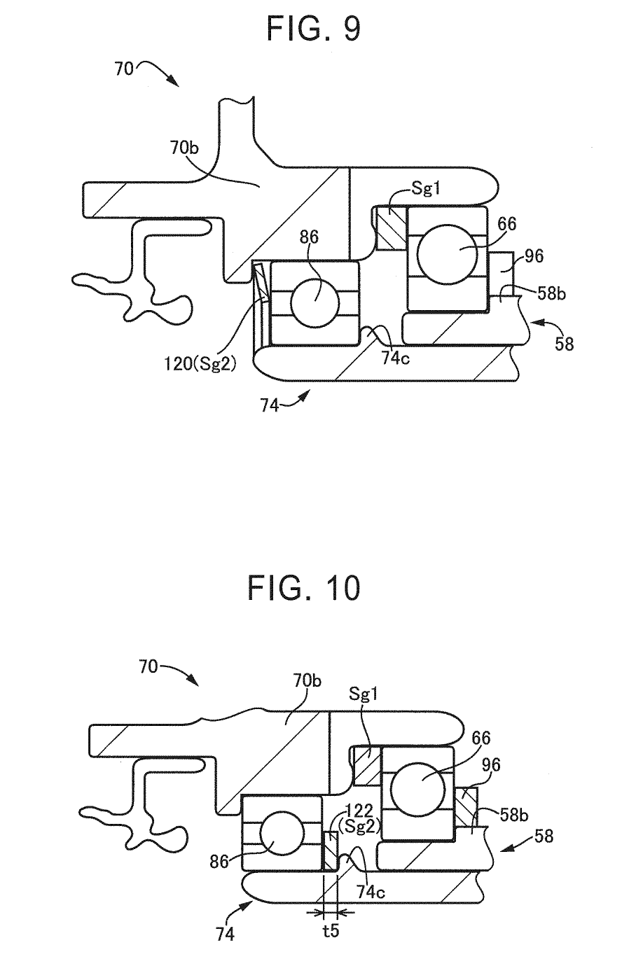

FIG. 9 is a view to describe a rear-wheel driving force distribution device (a vehicle driving force distribution device) of another embodiment of the present disclosure. The rear-wheel driving force distribution device of another embodiment of the present disclosure is different from the rear-wheel driving force distribution device 30 of Embodiment 1 in that a second backlash eliminating shim Sg2 disposed between a second support portion 70b of a bearing holding member 70 and a bearing 86 press-fitted to an end of an intermediate shaft 74 on an opposite side to a second-differential-device-36 side is a coned disc spring 120, and other configurations thereof are generally the same as the rear-wheel driving force distribution device 30 of Embodiment 1.

As illustrated in FIG. 9, the coned disc spring 120 as the second backlash eliminating shim Sg2 is disposed in a pressurized state between the second support portion 70b of the bearing holding member 70 and the bearing 86 press-fitted to the end of the intermediate shaft 74, and due to a biasing force of the coned disc spring 120, an end of the intermediate shaft 74 on the second-differential-device-36 side is moved toward a pinion-shaft-36f side in a second-rotation-axis-C2 direction relative to the bearing holding member 70, namely, the differential carrier 54. Accordingly, the intermediate shaft 74 abuts with the pinion shaft 36f, so that a differential case 36c in which the pinion shaft 36f is secured moves toward a differential-case-cover-76 side in the second-rotation-axis-C2 direction, and a gap in the second-rotation-axis-C2 direction between a bearing 84 press-fitted to a projection 36e of the differential case 36c and a bearing holding portion 76b of a differential case cover 76 is filled, thereby making it possible to restrain backlash of the intermediate shaft 74 with respect to the bearing holding member 70 and backlash of the differential case 36c with respect to the differential case cover 76.

As described above, with the rear-wheel driving force distribution device of the present embodiment, the second backlash eliminating shim Sg2 is the coned disc spring 120 disposed in a pressurized state between the bearing holding member 70 and the bearing 86, and the intermediate shaft 74 is moved along the second-rotation-axis-C2 direction relative to the bearing holding member 70, namely, the differential carrier 54 by a biasing force of the coned disc spring 120, so as to restrain the backlash of the intermediate shaft 74 with respect to the bearing holding member 70 and the backlash of the differential case 36c with respect to the differential case cover 76. Thus, with the use of the coned disc spring 120 as the second backlash eliminating shim Sg2, it is possible to restrain the backlash of the intermediate shaft 74 with respect to the bearing holding member 70 and the backlash of the differential case 36c with respect to the differential case cover 76, and it is possible to preferably reduce the number of components for the second backlash eliminating shim Sg2 as managing components provided to eliminate the backlash of the differential case 36c and the intermediate shaft 74.

FIG. 10 is a view to describe a rear-wheel driving force distribution device (a vehicle driving force distribution device) of another embodiment of the present disclosure. The rear-wheel driving force distribution device of another embodiment of the present disclosure is different from the rear-wheel driving force distribution device 30 of Embodiment 1 in that an annular plate material 122 as a second backlash eliminating shim Sg2 configured to restrain backlash of an intermediate shaft 74 with respect to a bearing holding member 70 and backlash of a differential case 36c with respect to a differential case cover 76 is disposed between a bearing 86 press-fitted to an end of the intermediate shaft 74 on an opposite side to a second-differential-device-36 side and a stopper portion 74c formed in the end of the intermediate shaft 74 on the opposite side to the second-differential-device-36 side, and other configurations thereof are generally the same as the rear-wheel driving force distribution device 30 of Embodiment 1.

As illustrated in FIG. 10, for the annular plate material 122 as the second backlash eliminating shim Sg2, several types of annular plate materials 122 having respective thicknesses t5 in a second-rotation-axis-C2 direction, which differ by 0.1 mm, for example, are prepared as managing components. When the annular plate material 122 is disposed between the bearing 86 press-fitted to the end of the intermediate shaft 74 and the stopper portion 74c formed in the end of the intermediate shaft 74, an end of the intermediate shaft 74 on the second-differential-device-36 side moves toward a pinion-shaft-36f side in the second-rotation-axis-C2 direction so as to abut with the pinion shaft 36f, so that a differential case 36c in which the pinion shaft 36f is secured moves toward a differential-case-cover-76 side in the second-rotation-axis-C2 direction. Hereby, by changing the thickness t5 of the annular plate material 122, a gap in the second-rotation-axis-C2 direction between the second support portion 70b of the bearing holding member 70 and the bearing 86 press-fitted to the end of the intermediate shaft 74 is filled and a gap in the second-rotation-axis-C2 direction between a bearing 84 press-fitted to a projection 36e of the differential case 36c and a bearing holding portion 76b of the differential case cover 76 is filled.

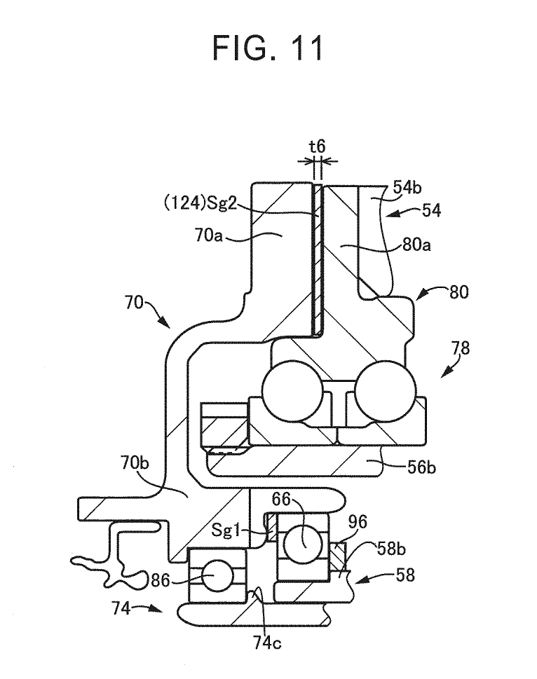

FIG. 11 is a view to describe a rear-wheel driving force distribution device (a vehicle driving force distribution device) of another embodiment of the present disclosure. The rear-wheel driving force distribution device of another embodiment of the present disclosure is different from the rear-wheel driving force distribution device 30 of Embodiment 1 in that an annular plate material 124 as a second backlash eliminating shim Sg2 configured to restrain backlash of an intermediate shaft 74 with respect to a bearing holding member 70 and backlash of a differential case 36c with respect to a differential case cover 76 is disposed between a first support portion 70a of the bearing holding member 70 and a projection 80a of an outer ring 80 of a bearing 78 supported by a differential carrier 54, and other configurations thereof are generally the same as the rear-wheel driving force distribution device 30 of Embodiment 1.

As illustrated in FIG. 11, for the annular plate material 124 as the second backlash eliminating shim Sg2, several types of annular plate materials 124 having respective thicknesses t6 in a second-rotation-axis-C2 direction, which differ by 0.1 mm, for example, are prepared as managing components. When the annular plate material 124 is disposed between the first support portion 70a of the bearing holding member 70 and the projection 80a of the outer ring 80 of the bearing 78, the intermediate shaft 74 can be moved relative to the differential carrier 54 in the second-rotation-axis-C2 direction, and a differential case 36c in which a pinion shaft 36f abutting with an end of the intermediate shaft 74 is secured can be moves relative to the differential case cover 76 in the second-rotation-axis-C2 direction. Hereby, by changing the thickness t6 of the annular plate material 124, a gap in the second-rotation-axis-C2 direction between a second support portion 70b of the bearing holding member 70 and a bearing 86 press-fitted to an end of the intermediate shaft 74 is filled and a gap in the second-rotation-axis-C2 direction between a bearing 84 press-fitted to a projection 36e of the differential case 36c and a bearing holding portion 76b of the differential case cover 76 is filled.

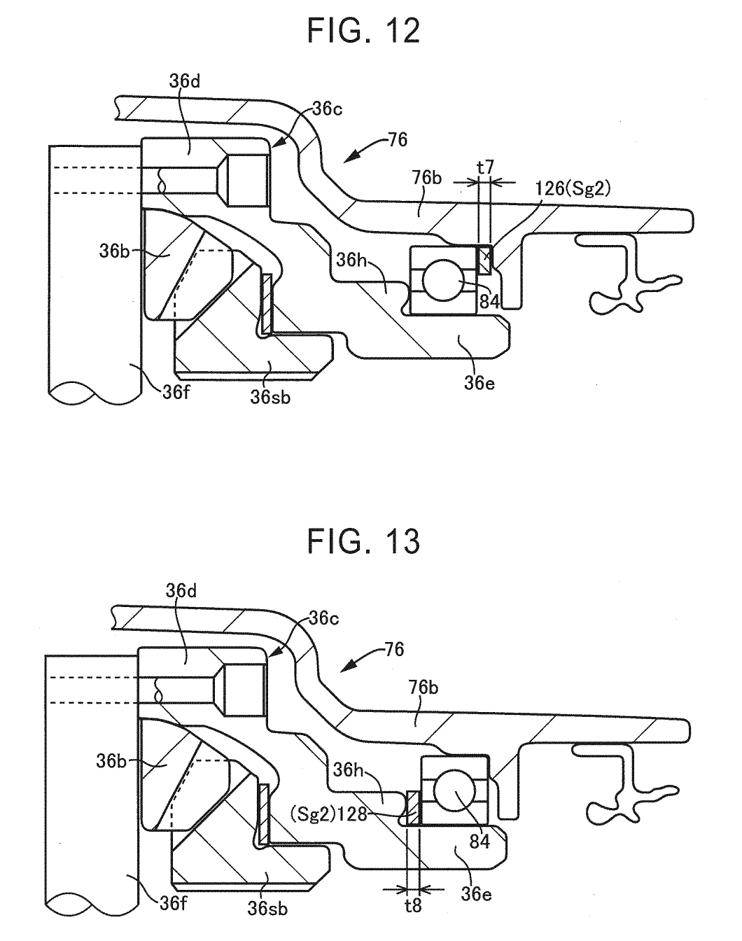

FIG. 12 is a view to describe a rear-wheel driving force distribution device (a vehicle driving force distribution device) of another embodiment of the present disclosure. The rear-wheel driving force distribution device of another embodiment of the present disclosure is different from the rear-wheel driving force distribution device 30 of Embodiment 1 in that an annular plate material 126 as a second backlash eliminating shim Sg2 configured to restrain backlash of an intermediate shaft 74 with respect to a bearing holding member 70 and backlash of a differential case 36c with respect to a differential case cover 76 is disposed between a bearing 84 press-fitted to a projection 36e of the differential case 36c and a bearing holding portion 76b of the differential case cover 76, and other configurations thereof are generally the same as the rear-wheel driving force distribution device 30 of Embodiment 1.

As illustrated in FIG. 12, for the annular plate material 126 as the second backlash eliminating shim Sg2, several types of annular plate materials 126 having respective thicknesses t7 in a second-rotation-axis-C2 direction, which differ by 0.1 mm, for example, are prepared as managing components. When the annular plate material 126 is disposed between the bearing 84 press-fitted to the projection 36e of the differential case 36c and the bearing holding portion 76b of the differential case cover 76, the differential case 36c is moved toward an intermediate-shaft-74 side in the second-rotation-axis-C2 direction relative to the differential case cover 76, namely, the differential carrier 54, so that a pinion shaft 36f secured in the differential case 36c abuts with an end of the intermediate shaft 74 on a second-differential-device-36 side, and the intermediate shaft 74 moves toward a bearing holding-member-70 side in the second-rotation-axis-C2 direction relative to the differential carrier 54, namely, the bearing holding member 70. Hereby, by changing the thickness t7 of the annular plate material 126, a gap in the second-rotation-axis-C2 direction between the bearing 84 press-fitted to the projection 36e of the differential case 36c and the bearing holding portion 76b of the differential case cover 76 is filled and a gap in the second-rotation-axis-C2 direction between a second support portion 70b of the bearing holding member 70 and a bearing 86 press-fitted to an end of the intermediate shaft 74 is filled.

FIG. 13 is a view to describe a rear-wheel driving force distribution device (a vehicle driving force distribution device) of another embodiment of the present disclosure. The rear-wheel driving force distribution device of another embodiment of the present disclosure is different from the rear-wheel driving force distribution device 30 of Embodiment 1 in that an annular plate material 128 as a second backlash eliminating shim Sg2 configured to restrain backlash of an intermediate shaft 74 with respect to a bearing holding member 70 and backlash of a differential case 36c with respect to a differential case cover 76 is disposed between a stopper portion 36h formed in the differential case 36c and a bearing 84 press-fitted to a projection 36e of the differential case 36c, and other configurations thereof are generally the same as the rear-wheel driving force distribution device 30 of Embodiment 1.

As illustrated in FIG. 13, for the annular plate material 128 as the second backlash eliminating shim Sg2, several types of annular plate materials 128 having respective thicknesses t8 in a second-rotation-axis-C2 direction, which differ by 0.1 mm, for example, are prepared as managing components. When the annular plate material 128 is disposed between the stopper portion 36h formed in the differential case 36c and the bearing 84 press-fitted to the projection 36e of the differential case 36c, the differential case 36c is moved toward an intermediate-shaft-74 side in the second-rotation-axis-C2 direction relative to the differential case cover 76, namely, a differential carrier 54, so that a pinion shaft 36f secured in the differential case 36c abuts with an end of the intermediate shaft 74 on a second-differential-device-36 side, and the intermediate shaft 74 moves toward a bearing-holding member-70 side in the second-rotation-axis-C2 direction relative to the differential carrier 54, namely, the bearing holding member 70. Hereby, by changing the thickness t8 of the annular plate material 128, a gap in the second-rotation-axis-C2 direction between the bearing 84 press-fitted to the projection 36e of the differential case 36c and a bearing holding portion 76b of the differential case cover 76 is filled and a gap in the second-rotation-axis-C2 direction between the second support portion 70b of the bearing holding member 70 and a bearing 86 press-fitted to an end of the intermediate shaft 74 is filled.

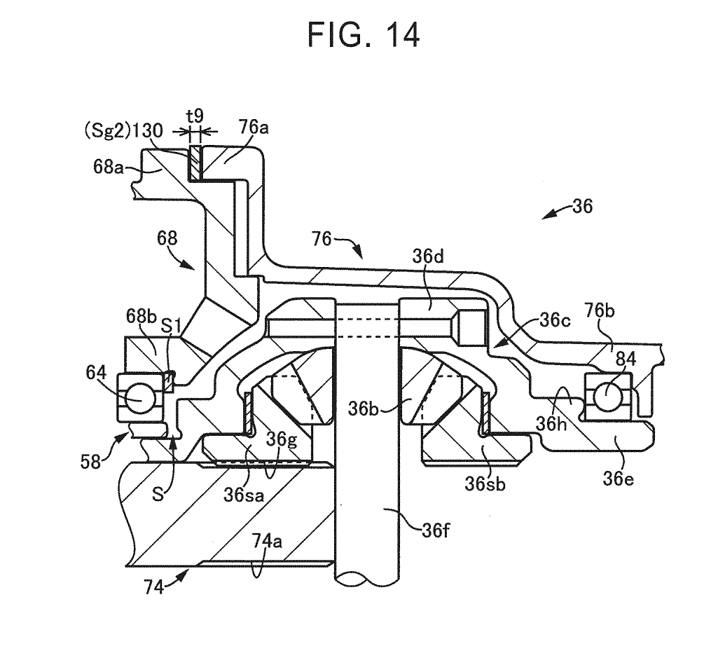

FIG. 14 is a view to describe a rear-wheel driving force distribution device (a vehicle driving force distribution device) of another embodiment of the present disclosure. The rear-wheel driving force distribution device of another embodiment of the present disclosure is different from the rear-wheel driving force distribution device 30 of Embodiment 1 in that an annular plate material 130 as a second backlash eliminating shim Sg2 configured to restrain backlash of an intermediate shaft 74 with respect to a bearing holding member 70 and backlash of a differential case 36c with respect to a differential case cover 76 is disposed between a first support portion 68a of a bearing holding member 68 and a fixed portion 76a of the differential case cover 76, and other configurations thereof are generally the same as the rear-wheel driving force distribution device 30 of Embodiment 1.

As illustrated in FIG. 14, for the annular plate material 130 as the second backlash eliminating shim Sg2, several types of annular plate materials 130 having respective thicknesses t9 in a second-rotation-axis-C2 direction, which differ by 0.1 mm, for example, are prepared as managing components. When the annular plate material 130 is disposed between the first support portion 68a of the bearing holding member 68 and the fixed portion 76a of the differential case cover 76, the differential case 36c can be moved relative to the bearing holding member 68, namely, a differential carrier 54 in the second-rotation-axis-C2 direction, and an intermediate shaft 74 abutting with a pinion shaft 36f secured in the differential case 36c can be moved relative to a bearing holding member 70, namely, the differential carrier 54 in the second-rotation-axis-C2 direction. Hereby, by changing the thickness t9 of the annular plate material 130, a gap in the second-rotation-axis-C2 direction between a bearing 84 press-fitted to a projection 36e of the differential case 36c and a bearing holding portion 76b of the differential case cover 76 is filled and a gap in the second-rotation-axis-C2 direction between a second support portion 70b of the bearing holding member 70 and a bearing 86 press-fitted to an end of the intermediate shaft 74 is filled.

The embodiments of the present disclosure have been described in detail with reference to the drawings, but the present disclosure is also applied to other aspects.

For example, in the above embodiments, the latching teeth 110a are formed in one step in the holder 110, but the latching teeth may be formed in two or more steps, namely, the latching teeth may be formed in several steps, for example.

Further, in the above embodiments, in the four-wheel-drive state of the four-wheel drive vehicle 10, the rear-wheel driving force distribution device 30 distributes a driving force transmitted from the engine 12 into the rear wheels 16L, 16R via the second differential device 36. However, the configuration of the rear-wheel driving force distribution device 30 may be applied to a front-wheel driving force distribution device configured to distribute the driving force transmitted from the engine 12 into the front wheels 14L, 14R in the two-wheel-drive state and the four-wheel-drive state of the four-wheel drive vehicle 10.

Further, in the above embodiments, the differential case cover 76 is attached to the differential carrier 54 via the bearing holding member 68, but the differential case cover 76 may be directly attached to the differential carrier 54, for example.

Further, in the above embodiments, the annular plate materials 122, 124, 126, 128, 130 are used as the second backlash eliminating shim Sg2, but a coned disc spring may be used instead of the annular plate materials 122, 124, 126, 128, 130.

Note that the above descriptions are merely one embodiment to the utmost, and the present disclosure can be performed in an embodiment to which various changes and improvements are added based on the knowledge of a person skilled in the art.

What is claimed is:

1. A driving force distribution device for a vehicle, the driving force distribution device being configured to distribute a driving force transmitted from a drive source to driving wheels, the driving force distribution device comprising:
a differential device including a differential case in which a pair of differential gears are assembled;
a differential carrier configured to fix the differential device so as to support the differential device rotatably around a first axis but immovably along a first-axis direction;
a ring gear including first connection and disconnection teeth and supported by the differential carrier rotatably around the first axis but immovably along the first-axis direction;
a connection and disconnection mechanism including a cylindrical member having a cylindrical shape, placed concentrically with a rotation axis of the differential gears, and splined to a shaft insertion portion formed in a first end of the differential case, and a connection and disconnection sleeve including second connection and disconnection teeth and disposed movably relative to the cylindrical member along a rotation-axis direction but non-rotatably relative to the cylindrical member, the connection and disconnection mechanism being configured to connect and disconnect a power transmission path between the ring gear and the differential case by moving the connection and disconnection sleeve in the rotation-axis direction between an engaged position and a disengaged position, the engaged position is a position at which the second connection and disconnection teeth of the connection and disconnection sleeve are engaged with the first connection and disconnection teeth of the ring gear, the disengaged position is a position at which the second connection and disconnection teeth of the connection and disconnection sleeve are disengaged from the first connection and disconnection teeth of the ring gear;
a pair of bearing holding members attached to the differential carrier and configured to hold a first bearing and a second bearing supporting both ends of the cylindrical member rotatably around the first axis;
an intermediate shaft passing through the cylindrical member and the shaft insertion portion of the differential case and configured such that a first end is connected to one of the differential gears and a second end is connected to a drive shaft in a power transmittable manner;
a differential case cover attached to either one of the differential carrier and the bearing holding member so as to support a second end of the differential case; and
a position adjusting shim configured to adjust positions, in the rotation-axis direction, of the first connection and disconnection teeth of the ring gear and the second connection and disconnection teeth of the connection and disconnection sleeve by moving a position of the connection and disconnection mechanism relative to the differential carrier in the rotation-axis direction,
the cylindrical member of the connection and disconnection mechanism and the differential case have a gap that is provided between the cylindrical member and the differential case.

2. The driving force distribution device for the vehicle, according to claim 1, wherein:
the position adjusting shim is an annular plate material having an annular shape and disposed between one of the pair of the bearing holding members and the first bearing held by the one of the pair of bearing holding members; and
the position adjusting shim is configured to move the position of the connection and disconnection mechanism relative to the differential carrier by moving a position of the cylindrical member relative to the differential carrier along the rotation-axis direction by a thickness of the annular plate material in the rotation-axis direction.

3. The driving force distribution device for the vehicle, according to claim 2, wherein
a first backlash eliminating shim configured to restrain backlash of the cylindrical member with respect to the other one of the pair of bearing holding members is provided between the other one of the pair of bearing holding members and the second bearing held by the other one of the pair of the bearing holding members.

4. The driving force distribution device for the vehicle, according to claim 2, wherein:
the other one of the pair of bearing holding members holds a third bearing supporting the second end of the intermediate shaft rotatably around the rotation axis; and
a second backlash eliminating shim configured to restrain backlash of the intermediate shaft with respect to the other one of the pair of bearing holding members and backlash of the differential case with respect to the differential case cover is provided between the other one of the pair of bearing holding members and the third bearing.

5. The driving force distribution device for the vehicle, according to claim 4, wherein:
the second backlash eliminating shim is an annular plate material having an annular shape and disposed between the other one of the pair of bearing holding members and the third bearing; and
the second backlash eliminating shim is configured to restrain the backlash of the intermediate shaft with respect to the other one of the pair of bearing holding members and the backlash of the differential case with respect to the differential case cover by moving the intermediate shaft relative to the differential carrier along the rotation-axis direction by a thickness of the annular plate material in the rotation-axis direction.

6. The driving force distribution device for the vehicle, according to claim 4, wherein:
the second backlash eliminating shim is a coned disc spring disposed in a pressurized state between the other one of the pair of bearing holding members and the third bearing; and
the second backlash eliminating shim is configured to restrain the backlash of the intermediate shaft with respect to the other one of the pair of bearing holding members and the backlash of the differential case with respect to the differential case cover by moving the intermediate shaft relative to the differential carrier along the rotation-axis direction by a biasing force of the coned disc spring.

7. The driving force distribution device for the vehicle, according to claim 1, wherein
the cylindrical member and the differential case have the gap that is set based on a thickness of the position adjusting shim such that the cylindrical member and the differential case do not interfere with each other.

8. The driving force distribution device for the vehicle, according to claim 1, wherein
the position adjusting shim is configured to adjust the positions of the first connection and disconnection teeth and the second connection and disconnection teeth when the cylindrical member, the bearing holding members, and the connection and disconnection sleeve are assembled.

9. The driving force distribution device for the vehicle, according to claim 3, wherein
the first backlash eliminating shim has a thickness that fills a gap, in the rotation-axis direction, between the other one of the pair of bearing holding members and the second bearing.
